(19) United States
(12) Patent Application Publication
(10) Pub. No.: US 2008/0172568 A1
(43) Pub. Date: Jul. 17, 2008

(54) Apparatus for power control of electronic device

(76) Inventors: Suk-Ki Yoon, Yongin-si (KR); Seong-Hye Park, Seoul (KR)

Correspondence Address: LAW OFFICE OF MONICA H CHOI, P O BOX 3424, DUBLIN, OH, 430160204, US

(21) Appl. No.: 12/004,375

(22) Filed: Dec. 20, 2007

(30) Foreign Application Priority Data
Jan. 17, 2007 (KR) 2007-05372

(51) Int. Cl. G06F 1/32; G06F 1/26

(52) U.S. Cl. 713/323; 713/324; 713/300

(57) ABSTRACT

For controlling power to an electronic device such as a CPU (central processing unit), each of at least two regulators provides a respective power at a common node of the electronic device. In addition, a logic unit controls each of the at least two regulators to provide variable power such as variable current at the common node depending on an operating mode of the electronic device.

This application claims priority under 35 USC §119 to Korean Patent Application No. 2007-05372, filed on Jan. 17, 2007 in the Korean Intellectual Property Office, the disclosure of which is incorporated herein in its entirety by reference.

### BACKGROUND OF THE INVENTION

1. Field of the Invention

The present invention relates generally to power control of an electronic device, and more particularly, to controlling multiple voltage regulators coupled to a common node according to different modes of operation of an electronic device such as a CPU (Central Processing Unit).

2. Background of the Invention

With miniaturization and integration of electronic devices, power consumption is an important factor. As for power consumption, a battery change should not prevent power from being applied to the chips of an electronic device. Because of miniaturization of electronic devices, installing a large-capacity battery may be difficult. Thus, minimizing power consumption but with sufficient power for each of multiple operating modes of the electronic device such as a CPU (central processing unit) is desired.

For example, a hardware accelerator within a portable terminal has a limit in using power, and thus cannot use a variety of external power supplies. A portable terminal operates according to the operating mode of its CPU such as a power-off mode, a shutdown mode, a sleep mode, an idle mode, and a view-finder/capture mode. In the prior art, a shutdown mode or sleep mode includes a long standby time with high current consumption.

Generally, a regulator is used in an electronic device to convert externally provided power to a form usable within the electronic device. When the electronic device operates in any mode different from a normal operating mode, the electronic device is powered off, and the regulator therein is also powered off for reducing leakage current.

However, when the regulator is powered off and then powered on, the CPU of the electronic device is powered by the regulator and is also powered off and then powered on. Accordingly, the CPU loses information about a previous operation and thus resumes the previous operation from the beginning resulting in inefficiency. In addition, the CPU is unable to immediately respond to commands received from a host.

Thus, power control within an electronic device is desired with minimized power consumption with reduced leakage current from any regulator even in a standby mode, such as a shutdown or sleep mode, but with the CPU of the electronic device responding to an access from a host with high speed.

### SUMMARY OF THE INVENTION

Accordingly, the present invention controls the respective current from each of multiple voltage regulators depending on the operating mode of the CPU of the electronic device.

In a method and apparatus for controlling power to an electronic device according to an aspect of the present invention, each of at least two regulators provides a respective power at a common node of the electronic device. In addition, a logic unit controls each of the at least two regulators to provide variable power such as variable current at the common node depending on an operating mode of the electronic device.

In an embodiment of the present invention, a first regulator is controlled to provide one of normal power or power-down power at the common node, and a second regulator is controlled to provide one of the normal power or standby power at the common node. In an example embodiment of the present invention, such normal power is higher than such standby power that is higher than such power-down power. Such power-down power is substantially zero power in an example embodiment of the present invention.

In another embodiment of the present invention, the first regulator and the second regulator are controlled to both provide the normal power simultaneously during a first operating mode of the electronic device. Alternatively, the first regulator is controlled to provide the power-down power while the second regulator is controlled to provide the standby power during a second operating mode of the electronic device. Additionally, the first regulator is controlled to provide the power-down power while the second regulator is controlled to provide the normal power during a third operating mode of the electronic device.

In a further embodiment of the present invention, at least one of the first and second regulators generates a regulated voltage at the common node during the first, second, and third operating modes of the CPU.

In an example embodiment of the present invention, the electronic device is a CPU (central processing unit). In that case, the first operating mode is during booting of the CPU, the second operating mode is when the CPU has been shutdown or is in sleep mode, and the third operating mode is during access of the CPU by a host.

In another embodiment of the present invention, a control unit generates control signals to the logic unit that controls the at least two regulators according to the control signals. For example, the control unit generates the control signals from reset and interrupt signals that are externally generated and from a CPU control signal generated by the CPU.

In a further embodiment of the present invention, the control unit generates a CPU clock signal. In that case, the logic unit further includes a multiplexer that transmits the CPU clock signal to the CPU during the first operating mode.

In another embodiment of the present invention, the CPU generates at least some of the control signals to the logic unit.

In this manner, the multiple regulators are controlled to provide variable power at the common node of the electronic device according to the operating mode of the electronic device.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of an apparatus for control of power to an electronic device such as a CPU (central processing unit) according to an embodiment of the present invention;

FIG. 2 is a timing diagram of signals during different operating modes of the electronic device in the apparatus of FIG. 1, according to an embodiment of the present invention; and

FIG. 3 is a flowchart of steps during different operating modes of the electronic device in the apparatus of FIG. 1, according to an embodiment of the present invention.

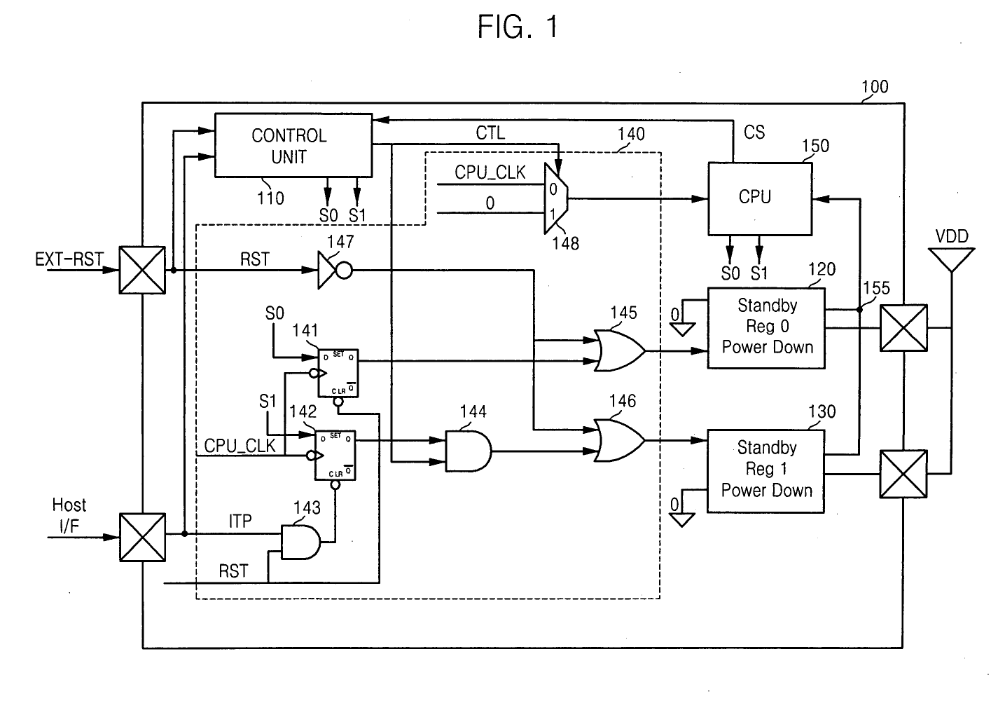

The figures referred to herein are drawn for clarity of illustration and are not necessarily drawn to scale. Elements having the same reference number in FIGS. 1, 2, and 3 refer to elements having similar structure and/or function.

### DETAILED DESCRIPTION OF THE INVENTION

FIG. 1 is a block diagram of an apparatus 100 for power control of an electronic device such as a CPU (central processing unit) 150, according to an embodiment of the present invention. Referring to FIG. 1, the apparatus 100 includes a control unit 110, a first regulator 120, a second regulator 130, and a logic unit 140. A system including the power controlling apparatus 100 and the CPU 150 may be implemented as a portable terminal, according to an embodiment of the present invention.

The control unit 110 generates a CPU clock signal CPU_CLK according to an embodiment of the present invention. For example, the control unit 110 includes a phase locked loop (PLL) circuit (not shown), a frequency divider (not shown), etc. for generating the CPU clock signal CPU_CLK. In an example embodiment of the present invention, the control unit 110 provides the CPU clock signal CPU_CLK to the CPU 150. Alternatively, the control unit 110 outputs a CPU mode control signal CTL to a multiplexer 148 that selectively outputs the CPU clock signal CPU_CLK to the CPU 150 according to the CPU mode control signal CTL.

In addition, the control unit 110 controls the logic unit 140 according to an embodiment of the present invention. By controlling the logic unit 140, the control unit 110 controls (e.g., changes or maintains) the respective power mode of each of the two regulators 120 and 130.

The control unit 110 receives a CPU control signal CS generated by the CPU for indicating an operating mode of the CPU 150. For example, when the CPU 150 enters a standby mode (such as a shutdown mode or a sleep mode) from another type of operating mode, the CPU control signal CS indicating such a change in the operating mode of the CPU 150 is generated by the CPU 150 to the control unit 110 for being stored in a register (not shown) within the control unit 110.

The control unit 110 does not need to output the CPU clock signal CPU_CLK to the CPU 150 when the operating mode of the CPU 150 is a shutdown mode or a sleep mode as indicated by the CPU control signal CS. In that case, the control unit sets the CPU mode control signal CTL to a predetermined logic level, such as the logic high level ‘1’, to the multiplexer 148. Accordingly, the CPU clock signal CPU_CLK is not transmitted by the multiplexer 148 to the CPU 150.

The logic unit 140 includes a first flip-flop 141, a second flip-flop 142, an inverter 147, a first AND-gate 143, a second AND-gate 144, a first OR-gate 145, and a second OR-gate 146. A first control signal S0 is applied to a D-input of the first flip-flop 141, and a second control signal S1 is applied to a D-input of the second flip-flop 142. Such control signals S0 and S1 control the respective power modes of the first and second regulators 120 and 130 according to the operating mode of the CPU 150.

In one embodiment of the present invention, the CPU 150 directly generates such control signals S0 and S1. Alternatively, the control unit 110 generates such control signals S0 and S1 in response to the CPU control signal CS. The first and second flip-flops 141 and 142 have the CPU clock signal CPU_CLK applied at the clock inputs. A Q-output of the first flip-flop 141 is input by the first OR-gate 145, and a Q-output of the second flip-flop 142 is input by the second AND-gate 144.

In addition, a reset signal RST is applied at a terminal reset pin EXT_RST and a host interrupt signal ITP is generated via a host interface by a host of the CPU 150. The reset signal RST and the host interrupt signal ITP are directly input by the logic unit 140 in FIG. 1. Alternatively, the reset signal RST and/or the host interrupt signal ITP may be received by the logic unit 140 via the control unit 110.

The inverter 147 inverts the reset signal RST to generate an output that is input by the first and second OR-gates 145 and 146. An inversion of the reset signal RST is also applied at a CLR input of the first flip-flop 141, and an inversion of an output of the first AND-gate 143 is applied at a CLR input of the second flip-flop 142. The first AND-gate 143 inputs the reset signal RST and the interrupt signal ITP. The second AND-gate 144 inputs the CPU mode control signal CTL from the control unit 110.

Each of the two regulators 120 and 130 operates in a respective power mode to provide a respective power at a common node 155 of the CPU 150. Each of the regulators 120 and 130 operates in one of a respective set of power modes depending on the operating mode of the CPU 150. In addition, each of the two regulators 120 and 130 converts an external voltage (for example, VDD=1.8 V) into an internal voltage (for example, 1.5 V) at the common node 155 that is compatible for use in the system including the apparatus 100.

An example set of possible power modes for the first regulator 120 includes a normal mode and a power-down mode. The first regulator 120 provides a normal amount of power at the common node 155 during the normal mode, and provides a power-down amount of power at the common node 155 during the power-down mode.

An example set of possible power modes for the second regulator 130 includes a normal mode and a standby mode. The second regulator 130 provides the normal amount of power at the common node 155 during the normal mode, and provides a standby amount of power at the common node 155 during the standby mode.

In one embodiment of the present invention, the normal amount of power is the higher than the standby amount of power which is higher than the power-down amount of power. For example, the power-down amount of power may be when zero power is applied with zero current being applied at the common node 155 from the regulator 120 or 130. The standby amount of power may be for a relatively small amount of power such when several hundreds of micro-Ampere of current is applied at the common node 155 from the regulator 120 or 130. The normal amount of power may be for a relatively higher amount of power such as when several tens of milli-Ampere of current is applied at the common node 155 from the regulator 120 or 130.

In addition, each of the two regulators 120 and 130 converts an external voltage VDD of 1.8 V into an internal voltage of 1.5 V that is a regulated voltage applied at the common node 155 during the normal mode and the standby mode. During the power-down mode, the regulator 120 or 130 does not generate any voltage or current at the common node 155.

Each of the two regulators 120 and 130 may also supply power not only to the CPU 150 but also to the other peripherals (not shown) as well. In addition, the names of the power modes may vary according to manufacturers. Furthermore, the present invention may be practiced with other levels of the voltage and current generated at the common node 155 by each of the regulators 120 and 130. Additionally, the present invention may be practiced with the regulators 120 and 130 generating power at the common node 155 for any type of electronic device aside from the example of the CPU 150.

Referring to FIG. 1, the first regulator 120 does not operate in the standby mode because a standby terminal of the first regulator 120 is always set to a predetermined logic level (such as the logic low level ‘0’). The first regulator 120 operates in one of the power-down mode or the normal mode depending on the logic level at a power-down terminal of the first regulator 120. For example, when the power-down terminal of the first regulator 120 is set to the logic high level ‘1’, the first regulator 120 operates in the power-down mode to provide the power-down power at the common node 155. Alternatively, when the power-down terminal of the first regulator 120 is set to the logic low level ‘0’, the first regulator 120 operates in the normal mode to provide the normal power at the common node 155.

The second regulator 130 does not operate in the power-down mode because a power-down terminal of the second regulator 130 is always set to the predetermined logic level (such as the logic low level ‘0’). The second regulator 130 operates in the standby mode or the normal mode depending on the logic level at a standby terminal of the second regulator 130. For example, when the standby terminal of the second regulator 130 is set to the logic high level ‘1’, the second regulator 130 operates in the standby mode to provide the standby power at the common node 155. Alternatively, when the standby terminal of the second regulator 130 is set to the logic low level ‘0’, the second regulator 130 operates in the normal mode to provide the normal power at the common node 155.

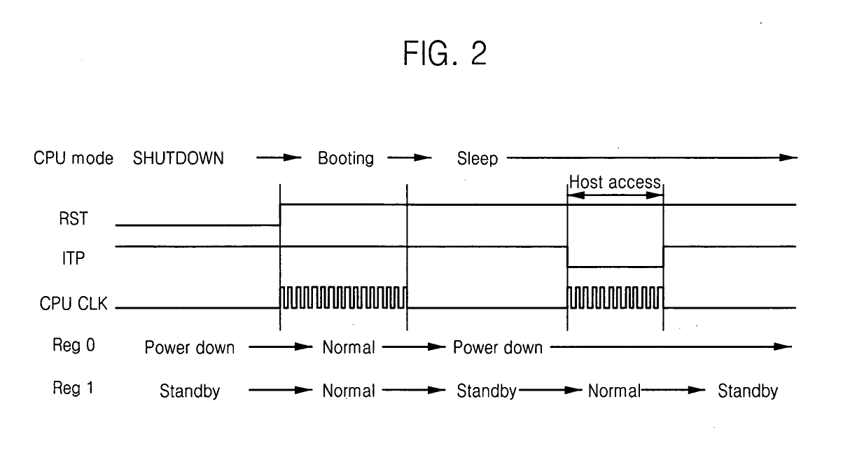

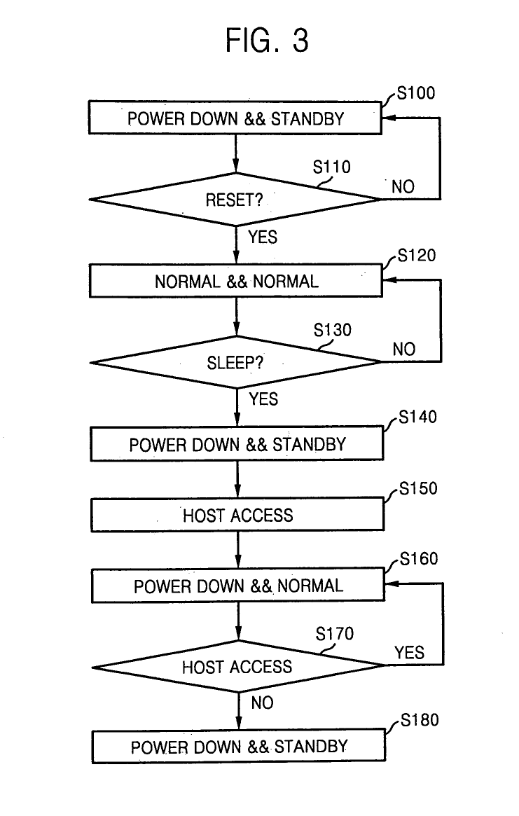

An example of changes to the operating modes of the first and second regulators 120 and 130 according to changes in the operating mode of the CPU 150 is now described with the timing diagram of FIG. 2 and the flow-chart of FIG. 3. Referring to FIGS. 1, 2, and 3, the CPU 150 is initially in a SHUTDOWN operating mode. In that case, the reset signal RST is set to the logic low level ‘0’, and the host interrupt signal ITP is set to the logic high level ‘1’. The reset signal RST is toggled every time a reset command is generated, and the host interrupt signal ITP is changed from the logic high level ‘1’ to the logic low level ‘0’ every time a host interrupt command is generated.

When the reset signal RST is at the logic low level ‘0’, the output of the inverter 147 that is input by the OR-gates 145 and 146 is at the logic high level ‘1’. Thus, the outputs of the OR-gates 145 and 146 are at the logic high level ‘1’. Accordingly, the first regulator 120 is set to operate in the power-down mode, and the second regulator 130 is set to operate in the standby mode, when the CPU 150 is in the SHUTDOWN operating mode (step S100 in FIG. 3).

Thereafter, when a reset command is generated, the reset signal RST transitions to the logic high level ‘1’ (step S110 in FIG. 3). Also in that case, the control unit 110 generates the CPU mode control signal CTL at the logic low level ‘0’ in response to the reset signal RST such that the CPU 150 operates in a Booting operating mode. In addition, the CPU 150 generates the control signal CS for indicating to the control unit 110 the operating mode of the CPU 150. For example, the control signal CS may indicate the booting state of the CPU 150, and such control signal CS is stored in the register of the control unit 110. Alternatively, such register may store information corresponding to the booting state of the CPU 150 in response to the reset signal RST.

The control unit 110 generates the control signals S0 and S1 that are input by the flip-flops 141 and 142, respectively, according to the operating mode of the CPU 150. For example, the control unit 110 generates the control signal S0 at the logic low level and the control signal S1 at the logic low level when the CPU 150 is in the Booting operating mode. The present invention may also be practiced with the CPU 150 generating the control signals S0 and S1.

During the Booting operating mode of the CPU 150, the first OR gate 145 and the second OR-gate 146 both output the logic low level such that the first and second regulators 120 and 130 are both set to operate in the normal mode (step S120 of FIG. 3). During such Booting operating mode of the CPU 150, the two regulators 120 and 130 each provide the high level of current of the normal mode to the CPU 150.

Also during the Booting operating mode of the CPU 150, the control unit 110 sets the CPU mode control signal CTL to the logic low level ‘0’. In that case, the multiplexer 148 transmits the CPU clock signal CPU_CLK to the CPU 150.

Thereafter when the CPU 150 enters into a Sleep operating mode (step S130 of FIG. 3), the CPU 150 activates the control signal CS to the control unit 110. In response, the control unit 110 sets the CPU mode control signal CTL to the logic high level ‘1’. In that case, the multiplexer 148 does not transmit the CPU clock signal CPU_CLK to the CPU 150.

During such Sleep operating mode of the CPU 150, the control unit 110 or the CPU 150 generates the control signals S0 and S1 both set to the logic high level ‘1’. As a result, the first regulator 120 is set to the power-down mode, and the second regulator 130 is set to the standby mode (step S140 of FIG. 3).

In this manner, at least one of the two regulators 120 and 130 is maintained in the standby mode to provide some current at the common node 155 even when the CPU 150 is in a standby operating mode such as the SHUTDOWN mode or the Sleep mode. Thus, the apparatus 100 of FIG. 1 supplies a minimum amount of power at the common node 155 for maintaining the power of the CPU 150.

Thus, the CPU 150 may still store information for a recent operation such as an address of a program recently performed by the CPU 150. For example, the standby power provided by the second regulator 130 to a program counter (e.g., a pc) register in the CPU 150 maintains the information stored therein. Accordingly, the CPU 150 may perform a subsequent operation according to such maintained information such that the CPU 150 may more immediately respond to a command from the host.

Referring to FIGS. 1, 2, and 3, while the CPU 150 is in the sleep mode, the host generates the host interrupt signal IPT set to the logic low level ‘0’ to the CPU 150 for accessing the CPU 150 by the host (step S150 of FIG. 3). In that case, the CPU 150 either performs an operation corresponding to the host interrupt signal IPT or enters into a normal CPU operating mode, while substantially maintaining the sleep mode.

The duration of the CPU 150 in the normal CPU operating mode is substantially shorter than the duration of the CPU 150 being in the Sleep mode. Accordingly, FIG. 2 illustrates a case that the CPU 150 performs an operation corresponding to the host interrupt signal IPT while maintaining the Sleep mode.

With the host interrupt signal IPT set to the logic low level ‘0’, the output the first AND gate 143 is set to the logic low level ‘0’. An inversion of the output of the first AND gate 143 is applied at the clear terminal CLR of the second flip-flop 142 such that the Q-output of the second flip-flop 142 is set to the logic low level ‘0’ and such that the output the second AND gate 144 is set to the logic low level ‘0’. Therefore, the output of the second OR gate 146 is set to the logic low level ‘0’, and thus the second regulator 130 is set to the normal mode. The first regulator 120 is maintained to be set to the power-down mode.

In this manner, when the CPU 150 enters into a host access section in FIG. 2 from the host interrupt (step S150 of FIG. 3), the control unit 110 controls one of the two regulators 120 and 130 to enter into the normal mode (step S160 of FIG. 3). Preferably, the control unit 110 sets one of the regulators 120 and 130 already providing a level of current that is closer to the normal mode current. In the example of FIG. 2, the second regulator 130 that was providing the standby current is controlled to operate in the normal mode to provide the normal mode current (i.e., the normal mode power) at the common node 155. The first regulator 120 is maintained to operate in the power-down mode. Alternatively, if the host access is for an operation requiring much current at the CPU 150, the CPU 150 may generate the control signal CS to control the first and second regulators 120 and 130 to both operate in the normal mode.

Thereafter, when the host access is completed (step S170), either the control unit 110 or the CPU 150 generates the control signals S0 and S1 to the first and second flip-flops 141 and 142 such that that the second regulator 130 re-enters the standby mode with the first regulator 120 remaining in the power-down mode (step S180 of FIG. 3).

In this manner, the respective output node of each of the regulators 120 and 130 having the regulated voltage generated thereon is directly connected to the common node 155 for the CPU 150. At least one of the regulators 120 and 130 provides some power and generates the regulated voltage at the common node 155 during the operating modes of the CPU 150 illustrated in FIG. 2.

While the present invention has been particularly shown and described with reference to exemplary embodiments thereof, it will be understood by those of ordinary skill in the art that various changes in form and details may be made therein without departing from the spirit and scope of the present invention as defined by the following claims.

The present invention is limited only as defined in the following claims and equivalents thereof.

What is claimed is:

1. An apparatus for controlling power to an electronic device, the apparatus comprising:
at least two regulators each providing a respective power at a common node of the electronic device; and
a logic unit that controls each of the at least two regulators to provide variable power at the common node depending on an operating mode of the electronic device.

2. The apparatus of claim 1, wherein the at least two regulators includes:
a first regulator that is controlled to provide one of normal power or power-down power at the common node; and
a second regulator that is controlled to provide one of normal power or standby power at the common node.

3. The apparatus of claim 2, wherein said normal power is higher than said standby power that is higher than said power-down power.

4. The apparatus of claim 3, wherein said power-down power is substantially zero power.

5. The apparatus of claim 4, wherein the first regulator and the second regulator are controlled to both provide said normal power simultaneously during a first operating mode of the electronic device, and wherein the first regulator is controlled to provide said power-down power while the second regulator is controlled to provide said standby power during a second operating mode of the electronic device, and wherein the first regulator is controlled to provide said power-down power while the second regulator is controlled to provide said normal power during a third operating mode of the electronic device.

6. The apparatus of claim 5, wherein at least one of the first and second regulators generates a regulated voltage at the common node during the first, second, and third operating modes of a CPU that is said electronic device.

7. The apparatus of claim 5, wherein the electronic device is a CPU (central processing unit), and wherein the first operating mode is during booting of the CPU, the second operating mode is when the CPU has been shutdown or is in sleep mode, and the third operating mode is during access of the CPU by a host.

8. The apparatus of claim 7, further comprising:
a control unit for generating control signals to the logic unit that controls the at least two regulators according to said control signals;
wherein the control unit generates the control signals from reset and interrupt signals that are externally generated and from a CPU control signal generated by the CPU.

9. The apparatus of claim 8, wherein the control unit generates a CPU clock signal, and wherein the logic unit further includes:
a multiplexer that transmits the CPU clock signal to the CPU during the first operating mode.

10. The apparatus of claim 8, wherein the CPU generates at least some of the control signals to the logic unit.

11. An apparatus for controlling power to an electronic device, the apparatus comprising:
at least two regulators each providing a respective power at a common node of the electronic device; and
means for providing variable power from the at least two regulators at the common node depending on an operating mode of the electronic device.

12. The apparatus of claim 11, wherein the at least two regulators includes:
a first regulator that is controlled to provide one of normal power or power-down power at the common node; and
a second regulator that is controlled to provide one of normal power or standby power at the common node.

13. The apparatus of claim 12, wherein said normal power is higher than said standby power that is higher than said power-down power.

14. The apparatus of claim 13, wherein said power-down power is substantially zero power.

15. The apparatus of claim 14, wherein the first regulator and the second regulator are controlled to both provide said normal power simultaneously during a first operating mode of the electronic device, and wherein the first regulator is controlled to provide said power-down power while the second regulator is controlled to provide said standby power during a second operating mode of the electronic device, and wherein the first regulator is controlled to provide said power-down power while the second regulator is controlled to provide said normal power during a third operating mode of the electronic device.

16. The apparatus of claim 15, wherein at least one of the first and second regulators generates a regulated voltage at the common node during the first, second, and third operating modes of a CPU that is said electronic device.

17. The apparatus of claim 15, wherein the electronic device is a CPU (central processing unit), and wherein the first operating mode is during booting of the CPU, the second operating mode is when the CPU has been shutdown or is in sleep mode, and the third operating mode is during access of the CPU by a host.

18. The apparatus of claim 17, further comprising:
a control unit for generating control signals to a logic unit that controls the at least two regulators according to said control signals;
wherein the control unit generates the control signals from reset and interrupt signals that are externally generated and from a CPU control signal generated by the CPU.

19. The apparatus of claim 18, wherein the control unit generates a CPU clock signal, and wherein the logic unit further includes:
a multiplexer that transmits the CPU clock signal to the CPU during the first operating mode.

20. The apparatus of claim 18, wherein the CPU generates at least some of the control signals to the logic unit.
